(19) United States
(12) Patent Application Publication
(10) Pub. No.: US 2026/0065443 A1
(43) Pub. Date: Mar. 5, 2026

(54) METHOD AND APPARATUS FOR VIDEO RESTORATION

(71) Applicant: Electronics and Telecommunications Research Institute, Daejeon (KR)

(72) Inventors: Ji Wan KIM, Daejeon (KR); Do Hyung Kim, Sejong-si (KR)

(21) Appl. No.: 19/028,322

(22) Filed: Jan. 17, 2025

(30) Foreign Application Priority Data
Sep. 4, 2024 (KR) 10-2024-0120162

(51) Int. Cl. G06T 5/77; G06T 5/50; G06T 11/00

(52) U.S. Cl. CPC G06T 5/77; G06T 5/50; G06T 11/10; G06T 2207/10016; G06T 2207/10024

(57) ABSTRACT

A video restoration method includes: receiving a target video to restore and a source video for restoration; registering the source video with the target video; converting both videos from RGB to YUV channels; identifying areas with significant differences in Y channel values as light reflection highlights; restoring these areas by replacing the Y channel values in the target video with corresponding values from the registered source video; and converting the restored target video back from YUV to RGB channels to produce the final restored video.

### CROSS-REFERENCE TO RELATED APPLICATION

This application claims the benefit of and priority to Korean Patent Application No. 10-2024-0120162, filed on Sep. 4, 2024, the entire disclosure(s) of which is hereby incorporated herein by reference in its entirety.

### TECHNICAL FIELD

The present disclosure relates to a method and apparatus for video restoration. More specifically, the present disclosure relates to a method and apparatus for video restoration using a technology for removing light reflection highlight.

### BACKGROUND

The content to be described below merely provides background information related to the present embodiment and does not constitute the related art.

A light reflection highlight refers to a phenomenon in which a partial area in a video becomes excessively bright depending on positions of a camera and a light source, causing some information in the video to be lost. The light reflection highlight mainly occurs in a process in which light is secularly reflected from an object surface, and an area in which light reflection highlight occurs becomes white due to excessive brightness, causing information in the video to be lost. In the area in which the light reflection highlight occurs, detailed parts may be lost and a mismatch with color of a surrounding area may occur, thereby damaging visual consistency of the overall video. In related art for removing light reflection highlight, a partial differential equation (PDE) or a filtering scheme is mainly used.

The related art for removing light reflection highlight is performed by analyzing each component of a video to extract and remove reflection components. A scheme of the related art mainly aims at detecting light reflection highlight area in a video based on a complex mathematical model and naturally removing the light reflection highlight area. However, the related art for removing light reflection highlight depends on an estimated value rather than an actual value and often requires complex calculations. Another method is a method for replacing a highlight area using RGB values of a source video. However, there is a limitation that natural video restoration is difficult because color and brightness mismatch may occur between the restored area and a surrounding area.

### SUMMARY

The following summary presents a simplified summary of certain features. The summary is not an extensive overview and is not intended to identify key or critical elements. An aspect of the present disclosure is to provide a method and an apparatus for video restoration.

The aspects of the present disclosure are not limited to those mentioned above, and other aspects not mentioned herein will be clearly understood by those skilled in the art from the following description.

A video restoration method, comprising: receiving a target video to be restored and a source video to be used for restoration of the target video; registering the source video with reference to the target video; changing the target video and the registered source video from an RGB channel to a YUV channel; designating and selecting an area with a larger difference in Y channel value between the target video and the registered source video as an area in which light reflection highlight occurs; restoring the area in which the light reflection highlight occurs by replacing a Y channel value of the area in which the light reflection highlight occurs in the target video with a Y channel value of a corresponding area of the registered source video; and changing the target video in which the area in which the light reflection highlight occurs has been restored, from a YUV channel to an RGB channel to generate a restored video.

A video restoration apparatus comprising at least one memory configured to store instructions, and at least one processor, the at least one processor executing the instructions to perform the processes of: receiving a target video to be restored and a source video to be used for restoration of the target video; registering the source video with reference to the target video; changing the target video and the registered source video from an RGB channel to a YUV channel; designating and selecting an area with a larger difference in Y channel value between the target video and the registered source video as an area in which light reflection highlight occurs; restoring the area in which the light reflection highlight occurs by replacing a Y channel value of the area in which the light reflection highlight occurs in the target video with a Y channel value of a corresponding area of the registered source video; and changing the target video in which the area in which the light reflection highlight occurs has been restored, from a YUV channel to an RGB channel to generate a restored video.

An object of the present disclosure is to provide a method and apparatus for restoring information on an area in which light reflection highlight occurs in a target video using information on a corresponding area of a source video by utilizing a multi-view video.

Another object of the present disclosure is to provide a method for adjusting the luminance of a corresponding area in a source video through interpolation and replacing the area in which a light reflection highlight occurs in a target video with the adjusted luminance values from the source video.

The problems to be solved by the present disclosure are not limited to the problems described above, and other problems that are not described can be clearly understood by those skilled in the art from the description below.

According to an embodiment of the present disclosure, it is possible to restore information on the area in which the light reflection highlight occurs in the target video using information on the corresponding area of the source video by utilizing the multi-view video.

According to an embodiment of the present disclosure, a luminance-adjusting interpolation method is provided to resolve color and brightness mismatches between a restored area and its surrounding area.

The effects of the present disclosure are not limited to the effects described above, and other effects not described can be clearly understood by those skilled in the art from the description below.

These and other features and advantages are described in greater detail below.

### BRIEF DESCRIPTION OF THE DRAWINGS

FIG. 1 is a block diagram schematically illustrating a configuration of a video restoration apparatus according to an embodiment of the present disclosure.

FIG. 2A through FIG. 2C are diagrams illustrating results of registering a source video with reference to a target video according to an embodiment of the present disclosure.

FIG. 3A through FIG. 3C are diagrams illustrating a result of changing a target video and a registered source video from an RGB channel to a YUV channel according to an embodiment of the present disclosure.

FIG. 4 is a diagram illustrating a graph showing a distribution of Y channel values of the target video and the source video according to an embodiment of the present disclosure.

FIG. 5A through FIG. 5C are illustrative diagrams illustrating a method for restoring a target video by replacing a Y channel value of the target video with a Y channel value of the registered source video according to an embodiment of the present disclosure.

FIG. 6A and FIG. 6B are illustrative diagrams illustrating a method for calculating an estimated pixel value of an area in which light reflection highlight occurs in the target video.

FIG. 7A through FIG. 7C are diagrams illustrating a comparison between a video obtained by replacing the target video using an RGB value of the registered source video and a video obtained by replacement after luminance of a Y channel value is adjusted using an interpolation scheme.

FIG. 8 is a flowchart schematically illustrating a video restoration method according to an embodiment of the present disclosure.

FIG. 9 is a diagram schematically illustrating a configuration of an exemplary computing device that can be used to implement the apparatuses and methods described in the present disclosure.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of related known components and functions when considered obscuring the subject of the present disclosure will be omitted for the purpose of clarity and for brevity.

Additionally, various terms such as first, second, A, B, (a), (b), etc., are used solely for the purpose of differentiating one component from others but not to imply or suggest the substances, the order or sequence of the components. Throughout this specification, when parts “include” or “comprise” a component, they are meant to further include other components, not excluding thereof unless there is a particular description contrary thereto. The terms such as “unit,” “module,” and the like refer to units for processing at least one function or operation, which may be implemented by hardware, software, or a combination thereof.

The detailed description set forth below in conjunction with the appended drawings is intended to describe exemplary examples of the present disclosure and is not intended to represent the only examples in which the present disclosure may be practiced.

As used below, singular terms may include plural terms unless otherwise specified.

Hereinafter, the term “image” may be a still video or may be a frame of a video.

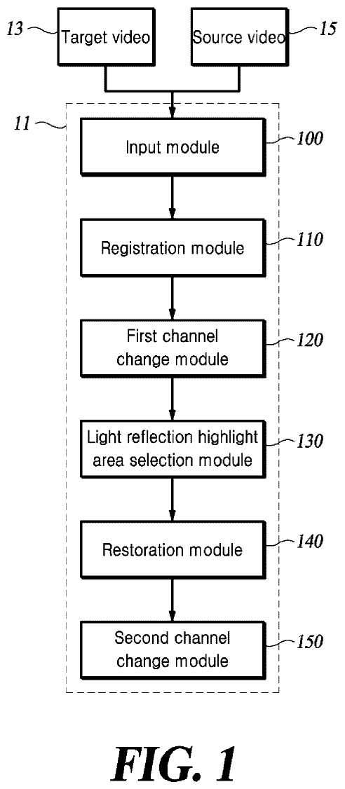

FIG. 1 is a block diagram schematically illustrating a configuration of a video restoration apparatus according to an embodiment of the present disclosure.

A video restoration apparatus 11 using a technology for removing light reflection highlight may include all or some of an input module 100, a registration module 110, a first channel change module 120, light reflection highlight area selection module 130, a restoration module 140, and a second channel change module 150. Not all blocks illustrated in FIG. 1 are essential components, and some blocks may be added, deleted, or changed in other embodiments. The components illustrated in FIG. 1 may be implemented as one or more software modules or components installed on one or more computing devices at one or more positions. In some implementations, one or more computing devices may be dedicated to a specific component. For example, the input and the registration may be performed by a computer device on the client side, and first channel change, light reflection highlight area selection, restoration, and second channel change may be performed by a computing device on the server side. In other implementations, a plurality of components may be executed on the same computing device.

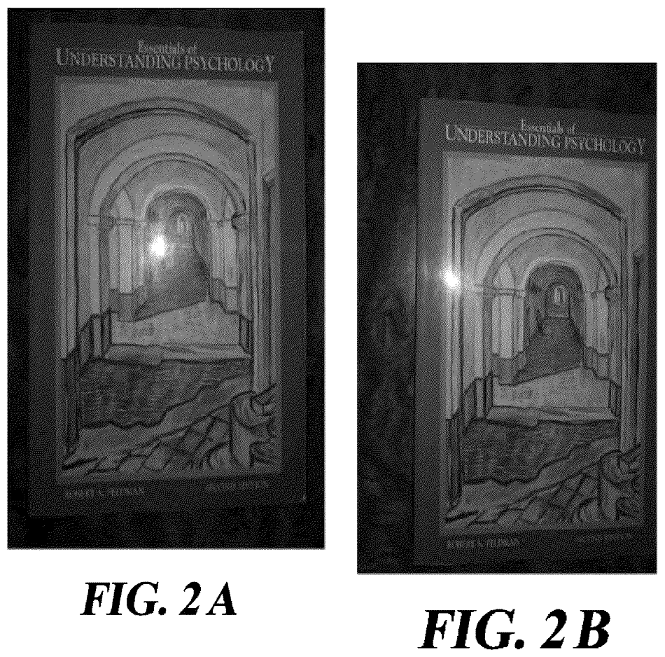

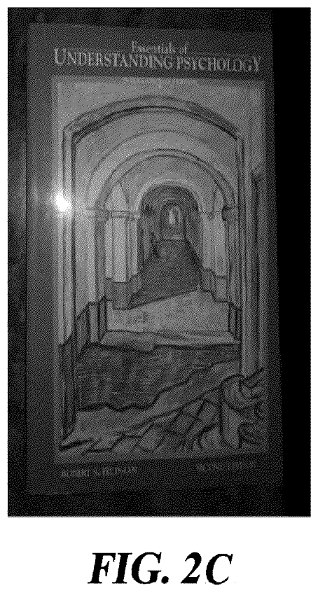

FIG. 2A through FIG. 2C are diagrams illustrating results of registering a source video with reference to a target video according to an embodiment of the present disclosure.

In the embodiment of the present disclosure, a target video 13 and a source video 15 may be acquired using a multi-view video. The multi-view video generally means a video obtained by photographing the same scene at various angles using a plurality of cameras. The multi-view video is used in various fields such as computer vision, 3D reconstruction, virtual reality (VR), and augmented reality (AR). Since, for the multi-view video, a plurality of cameras photograph the same scene from various viewpoints, there is the advantage of obtaining more accurate results when restoring a damaged area through integration of data from various viewpoints. For example, artifacts that occur at a specific viewpoint, such as the light reflection highlight, can be resolved using source videos captured from different viewpoints.

FIG. 2A illustrates the target video, and FIG. 2B illustrates the source video. It can be confirmed that the respective videos are obtained by photographing the same object, but center points are different from each other. This is because the videos are captured from different positions. The same object is photographed, but photographing points in time are different from each other, and therefore, areas in which the light reflection highlight occurs are also different from each other. As a result, it is easy to acquire the source video to be used for restoration of the target video by using the multi-view video.

There is another advantage of using the multi-view video. The target video 13 and the source video 15 may be complementary source videos. Since light reflection highlight may occur in an area of the source video 15 different from that of the target video 13, the target video 13 acts as the source video 15.

On the other hand, in the video restoration apparatus 11 using the technology for removing light reflection highlight, videos captured at different points in time may be collected to restore a damaged part of the video, and then, may be used in a preprocessing process of an application that requires a multi-view video.

The input module 100 is a module that receives the target video 13 to be restored by removing light reflection highlight and the source video 15 used for restoration of the target video. The video may be input by supporting various digital image or video file formats such as JPEG, PNG, BMP, TIFF, MP4, and AVI. A file may be uploaded to the device or selectively processed. Alternatively, a path for a file stored in the system may be designated and the file may be input. An input scheme is not limited to the example above.

The registration module 110 has a function of registering the input target video 13 and source video 15. Registration means a task of comparing two videos (or images) to match the videos or modifying the videos according to a specific criterion. A process of associating the same feature points, patterns, or objects between the two videos is included. The registration is mainly used in the field of computer vision or video processing. The registration is a technology for performing association in order to restore a damaged video or low-quality video to a high-quality video. For example, assuming that two CCTV cameras photograph the same space from different positions, center positions of respective videos appear differently since the two cameras photograph the same space from the different angles. A difference in position between the two videos is simply due to a difference between physical positions of the cameras. It is sufficient to apply translation to the center positions of the videos so that the center positions are matched with each other. A translation technology is a basic geometric transformation scheme for moving an image in parallel left and right or up and down in video processing or computer vision. In the translation technology, all pixels of videos are moved by a certain distance so that two videos have the same center.

FIG. 2A illustrates the target video, FIG. 2B illustrates the source video, and FIG. 2C illustrates a result of registering the source video with the target video as a reference. It can be seen that the source video has been converted to a position corresponding to the target video.

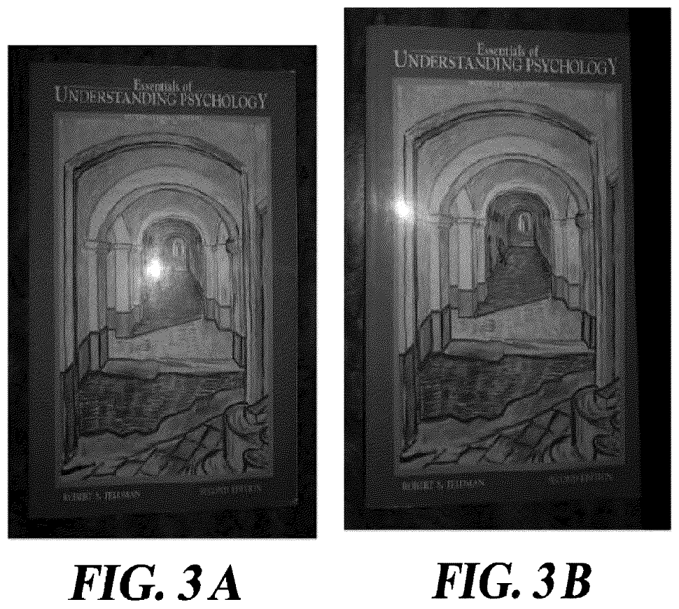

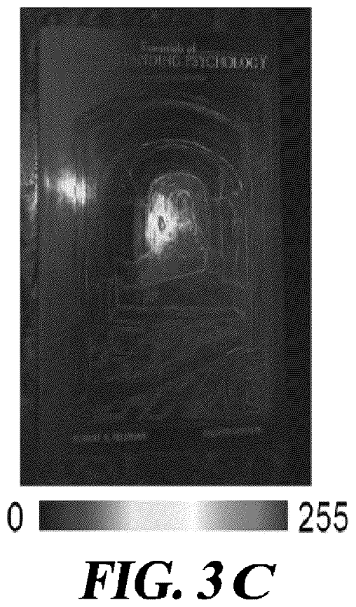

FIG. 3A through FIG. 3C are diagrams illustrating a result of changing a target video and a registered source video from an RGB channel to a YUV channel according to an embodiment of the present disclosure.

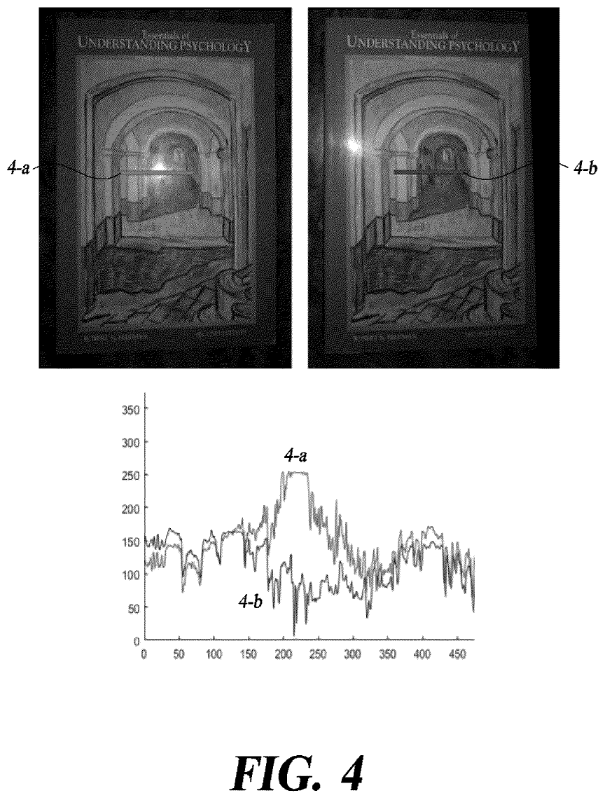

FIG. 4 is a diagram illustrating a graph showing a distribution of Y channel values of the target video and the source video according to an embodiment of the present disclosure.

RGB is an abbreviation for red, green, and blue. In a typical model, all colors in a digital video are represented as a combination of three basic colors. Each pixel has a specific color using a combination of the three colors, and each color component is represented as a value from 0 to 255.

The RGB channel is a representation of respective color components R, G, and B as independent images. For example, a red channel is an image that represents only a red component in the video, a green channel is an image that represents only a green component, and a blue channel is an image that represents only a blue component. Each RGB channel provides color information of the video, and a combination of information of all the channels forms the overall video. Color correction, filter application, video processing, and the like may be performed by adjusting or modifying a specific channel.

The YUV channel is a color model that is used to represent color in digital video processing. A YUV model represents color by separating luminance and chrominance, unlike the RGB model. The luminance is a physical quantity that represents the brightness of light in a video. The luminance mainly determines the brightness of a video and represents brightness information of the video. The higher the luminance, the brighter a corresponding part appears, and the lower the luminance, the darker a corresponding part appears. The chrominance is a component that represents hue and saturation. The chrominance describes a qualitative part of color and determines what an actual color is. The hue means a basic property of the color and is used to distinguish specific types of color such as red, blue, and yellow. The hue determines which wavelength of light enters eyes. The saturation represents the intensity or purity of a color. When the saturation is higher, the color looks clearer and mor intense, and when the saturation is lower, the color looks close to gray and appears blurry.

In the YUV model, the luminance is represented as the Y channel. This channel is calculated through weighted average of the R, G, and B values in the RGB model. The luminance provides main brightness information of a video by utilizing the fact that human eyes are more sensitive to brightness than color, and allows a shape and structure of a video to be recognized without representation of the color. The chrominance is represented as U and V. The UV channel represents remaining color information after a luminance component is subtracted from an RGB value. A U channel represents a difference between blue and luminance, and a V channel represents a difference between red and luminance. Formula 1 is a formula for changing an RGB channel to a YUV channel. Formula 2 is a formula for changing the YUV channel to an RGB channel.

$$[ \begin{matrix}Y = 0.299 R + 0.587 G + 0.1 \; 14 B \\ U = ( B - Y ) * 0.565 \\ V = ( R - Y ) * 0.713\end{matrix} ] \qquad [ Formula 1 ]$$

$$[ \begin{matrix}R = {Y}^{′} + 1.403 V \\ G = {Y}^{′} - 0.344 U - 0.714 V \\ B = {Y}^{′} + 1.77 U\end{matrix} ] \qquad [ Formula 2 ]$$

Each variable R, G, B, Y, U or V represents color information of the pixel. R, G, and B are color component values of red, green, and blue, respectively, and are integers ranging from 0 to 255. For example, when R is 0, this means there is no red at all, and when R is 255, this means that the red is maximum. Y is a luminance component with 0 indicating a darkest state (black) and 255 indicating a brightest state (white). U represents a difference between a blue component and the luminance. This is generally used after conversion into a range of −128 to +127. V represents a difference between a red component and the luminance. This is generally used after conversion into a range of −128 to +127.

FIG. 3A is a diagram illustrating a Y channel of the target video, FIG. 3B is a diagram illustrating a Y channel of the registered source video, and FIG. 3C is a diagram illustrating a Y channel difference map of the target video and the registered source video. It can be confirmed that a difference in Y channel value is large in the area in which the light reflection highlight occurs.

4-a and 4-b of FIG. 4 illustrate the scan lines of the target video and the registered source video, and the graph of FIG. 4 illustrates a graph of a distribution of the Y channel values of 4-a and 4-b of FIG. 4. It can be confirmed that the luminance value of 4-a of FIG. 4 is relatively higher than that of 4-b in the scan line. When a difference in Y channel value between the target video and the registered source video is large, this means that a difference in brightness is large, and thus, such an area can be estimated as the area in which the light reflection highlight occurs.

The first channel change module 120 performs RGB→YUV channel change on each pixel value of the target video and the registered source video through a calculation process of Formula 1. For example, RGB data for each pixel of the target video is collected, and R, G, and B values of each pixel are individually extracted. Each individually extracted value is calculated through the calculation process of Formula 1. The generated Y, U, and V values are combined to finally generate YUV data. The converted YUV data is transferred to a process in the next step or to a display device and utilized by a system using a YUV model.

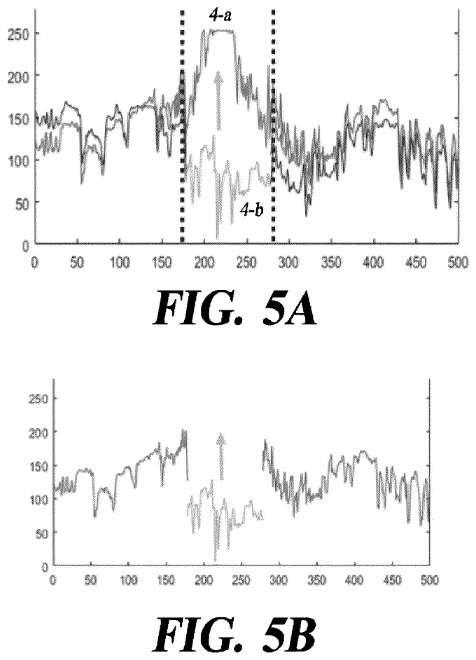

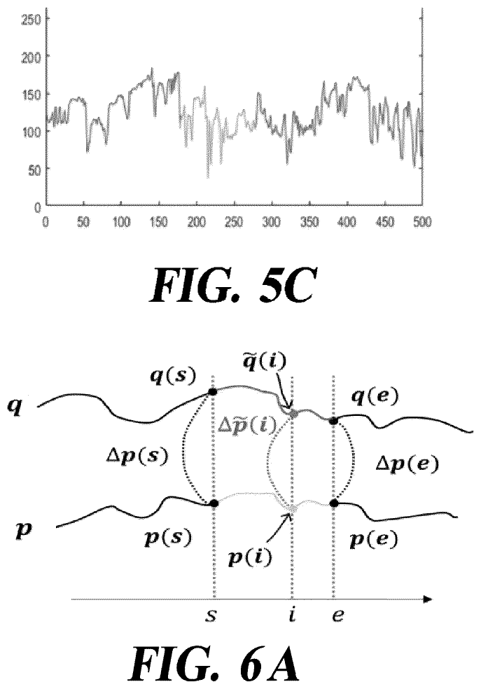

FIG. 5A through FIG. 5C are illustrative diagrams illustrating a method for restoring a target video by replacing a Y channel value of the target video with a Y channel value of the registered source video according to an embodiment of the present disclosure.

The light reflection highlight area selection module 130 designates and selects an area with a large difference in luminance value as an area in which light reflection highlight occurs by using the Y channel of the target video and the registered source video as a result of the channel change in the first channel change module 120. This is because the area with a large difference in luminance value is a restoration target.

In a graph of FIG. 5A, an area indicated by two dotted lines is an area in which a difference in Y channel value between a target video 4-a and a registered source video 4-b is large. For example, the light reflection highlight area selection module 130 may designate and select the area between the two dotted lines as the area in which the light reflection highlight occurs.

In FIG. 5B, a Y value distribution of the area designated and selected as the area in which the light reflection highlight occurs in the target video is erased, and only a Y value distribution of the area in which the light reflection highlight occurs in the registered source video is left.

FIG. 5C illustrates an example in which the area designated and selected as the area in which the light reflection highlight occurs in the target video is replaced with a Y value distribution of a corresponding area of the registered source video. However, when the replacement is directly performed without adjusting the Y value distribution of the corresponding area of the registered source video, a color light brightness mismatch may occur between the restored area and the surrounding area.

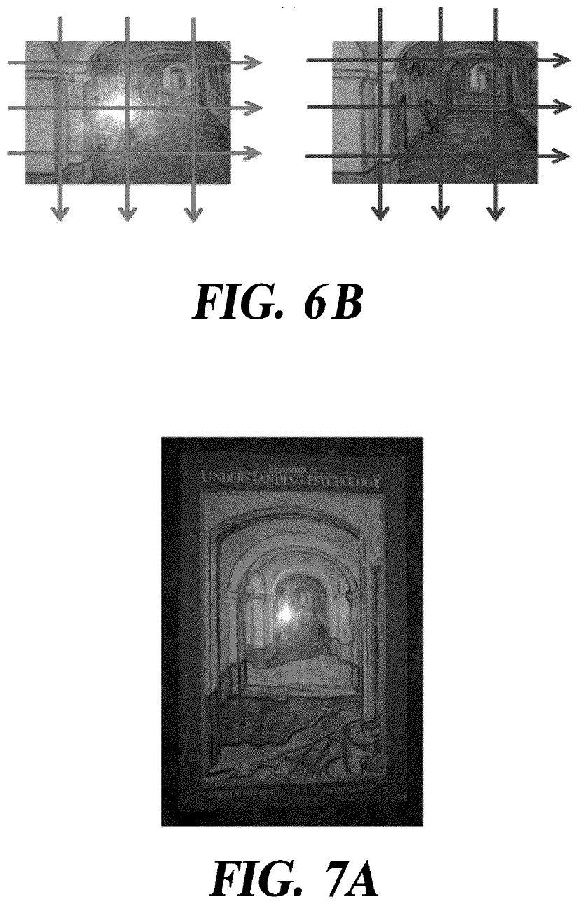

FIG. 6A and FIG. 6B are illustrative diagrams illustrating a method for calculating an estimated pixel value of an area in which light reflection highlight occurs in the target video.

The restoration module 140 has a function of restoring the area in which light reflection highlight occurs in the target video. In the embodiment of the present disclosure, the area in which light reflection highlight occurs in the target video is replaced using the Y channel value of the corresponding area of the registered source video. However, when the area in which light reflection highlight occurs in the target video is simply replaced using the Y channel value of the corresponding area of the registered source video, a mismatch in brightness between the restored area and the surrounding area may occur, and thus, the Y channel value of the target video is replaced after the luminance is adjusted using an interpolation scheme so that brightness levels of the target video and the registered source video are similar. Interpolation is a mathematical method of estimating a new value between data points that are already known. The interpolation scheme is used to fill with a value between two given points or to represent data more precisely. For example, linear interpolation is a scheme for calculating an intermediate value along a straight line between two points. The linear interpolation has the advantage of being simple and fast to calculate.

For the scan lines of the target video and the registered source video, pixel domains p and q in FIG. 6A are Y values of the registered source video and the target video, respectively. The pixel domain refers to a space where each pixel of an image is directly represented. In the pixel domain, an image is represented as a two-dimensional matrix, and each pixel represents color or brightness information of a specific position. When an i-th pixel value of the registered source video is p(i) and an i-th estimated pixel value of the target video is \tilde{q}(i), \tilde{q}(i)=p(i)+Δ\tilde{p}(i) is defined. Here, Δ\tilde{p}(i) is defined as in Formula 3.

$$Δ \tilde{p} ( i ) = \frac{1}{e - s} ( ( e - i ) Δ p ( s ) + ( i - s ) Δ p ( e ) ) \qquad [ Formula 3 ]$$

A start coordinate index of the light reflection highlight area in the scan line is denoted by S, an end coordinate index is denoted by e, Δp(s)=|q(s)−p(s)|, and Δp(e)=|q(e)−p(e)|.

When a pixel value calculation process using Formula 3 is applied to each pixel of all rows and columns in the light reflection highlight area as in FIG. 6B, respective values of the rows and columns can be [symbol] (i)=pᵣ (i)+Δ [symbol] (i), [symbol] (i)=p_{c} (i)+Δ [symbol] (i).

When a size of a window including the light reflection highlight area is k, a final Δ\tilde{p}(i) is calculated using an average value of Δ [symbol] (i) and Δ [symbol] (i) in Formula 4 to acquire a natural video. The window refers to a small area or sub-image selected to process or analyze a specific part of an image. The window is a concept that is mainly used in various video processing tasks such as filtering, edge detection, and feature extraction.

$$Δ \tilde{p} ( i ) = \frac{1}{2 {k}^{2}} {\sum }_{j} ( Δ ( j ) + Δ ( j ) ) \qquad [ Formula 4 ]$$

The restoration module 140 according to the embodiment of the present disclosure may calculate an estimated value of the Y value of the area in which the light reflection highlight occurs in the target video by using an interpolation scheme that defines a scheme of obtaining a local approximation based on linear interpolation in a nonlinear graph, as in Formulas 3 and 4.

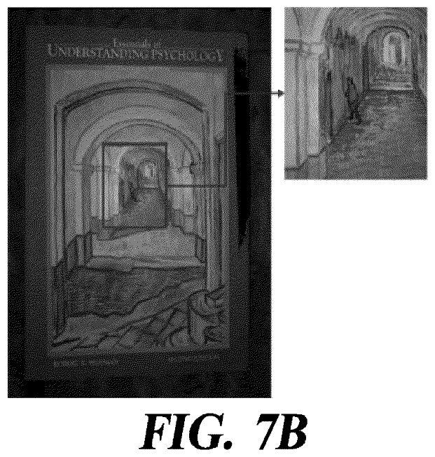

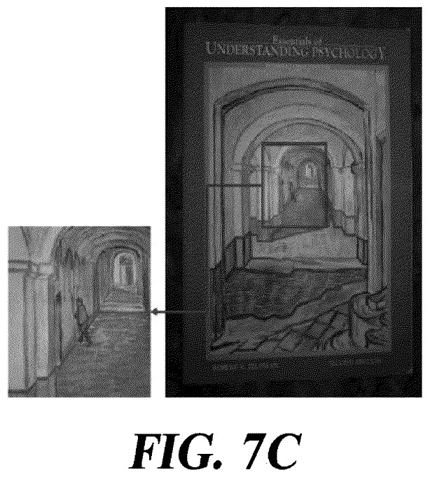

FIG. 7A through FIG. 7C are diagrams illustrating a comparison between a video obtained by replacing the target video using an RGB value of the registered source video and a video obtained by replacement after luminance of a Y channel value is adjusted using an interpolation scheme.

In a method of simply replacing the area in which the light reflection highlight occurs using the RGB value of the source video, a color and brightness mismatch may occur between the restored area and the surrounding area. In the embodiment of the present disclosure, an interpolation scheme capable of adjusting the luminance and performing value filling is used to solve this problem.

FIG. 7A illustrates the target video. FIG. 7B illustrates a video in which the area in which the light reflection highlight occurs in the target video is replaced using the RGB value of the corresponding area of the registered source video. FIG. 7C illustrates a video in which the area in which the light reflection highlight occurs in the target video is replaced using the luminance of the Y value of the corresponding area of the registered source video using the interpolation scheme, as in the embodiment of the present disclosure. Further, the right image of FIG. 7B and the left image of FIG. 7C illustrate videos in which the restored areas of the left image of FIG. 7B and the right image of FIG. 7C are enlarged.

Referring to the right image of FIG. 7B, the brightness mismatch between the restored area and the surrounding area can be confirmed. On the other hand, the left image of FIG. 7C illustrates a result of natural restoration such that the difference in brightness between the restored area and the surrounding area cannot be confirmed.

The second channel change module 150 has a function of changing the restored target video of the Y channel to an original RGB channel. Since the RGB model directly represents a color representation of the video, this is intended to acquire a final restored video. A calculation process for channel changing is the same as in the first channel change module 120, and Formula 2 is used in the calculation process for channel changing.

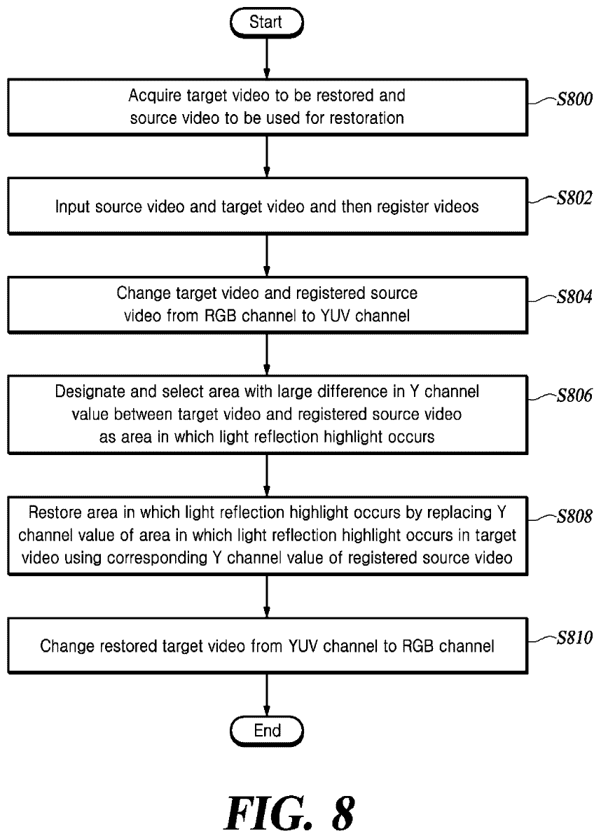

FIG. 8 is a flowchart schematically illustrating a video restoration method according to an embodiment of the present disclosure.

The video restoration apparatus 11 receives the target video to be restored and the source video to be used for restoration and performs a restoration process (S800). The target video and the source video may be acquired using a multi-view video. The multi-view video is generally obtained by photographing the same space from various angles using a plurality of cameras. Since points in time at which the same object is photographed are different, the areas in which the light reflection highlight occurs are also different. Therefore, when the multi-view video is used, there is an advantage in that it is easy to acquire the source video required to restore the area in which the light reflection highlight occurs, and it is possible to obtain more accurate results when a damaged area is restored.

After the target video and the source video are acquired, the target video and the source video are input to the video restoration apparatus 11 for video restoration. The video may be input by supporting various digital image or video file formats such as JPEG, PNG, BMP, TIFF, MP4, and AVI. A file may be uploaded to the device or selectively processed. Alternatively, a path for a file stored in the system may be designated and the file may be input. An input scheme is not limited to the example above.

After the video is input, the target video 13 and the source video 15 are registered. This is intended to associate the target video with the source video in order to restore the target video damaged due to the light reflection highlight to data of the source video. For example, in the case of the embodiment of the present disclosure, since the multi-view video is used, there is a difference in viewpoint of captured videos. Therefore, center positions of the videos are matched using translation (S802).

When the target video and the source video are registered, changing from the RGB channel to the YUV channel is performed (S804). In the calculation process for channel changing, Formula 1 is used. For example, RGB data for each pixel of the target video is collected, and R, G, and B values of each pixel are individually extracted. Each individually extracted value is calculated through the calculation process of Formula 1. The generated Y, U, and V values are combined to finally generate YUV data. The converted YUV data is used for processing of the next step.

Using the Y channels of the target video and the registered source video, an area with a large difference in luminance value is designated and selected as the area in which the light reflection highlight occurs (S806). This is because, since luminance represents a level of light brightness, the area with a large difference in luminance value can be estimated as the area in which the light reflection highlight occurs. This is a process of considering the area with a large difference in luminance value as a restoration target.

After the area in which the light reflection highlight occurs is designated and selected, the area in which the light reflection highlight occurs in the target video is replaced using the Y channel value of the corresponding area of the registered source video. When the replacement is performed without adjusting the value, a mismatch in the brightness of light between a restored area and a surrounding area may occur. Therefore, the luminance is adjusted using a luminance interpolation scheme. In the embodiment of the present disclosure, in the distribution of the Y value, the estimated value of the Y value of the area in which the light reflection highlight occurs in the target video is estimated using an interpolation scheme that defines a scheme for obtaining a local approximation based on linear interpolation in a nonlinear graph, for replacement (S808).

When the Y value of the area in which the light reflection highlight occurs in the target video is replaced with the Y value estimated using the interpolation scheme, the restored target video of the Y channel is changed to the original RGB channel (S810).

This is intended to acquire a finally restored video because the RGB model directly represents a color representation of the video. A channel changing process is the same as the RGB→YUV channel changing process (S804). For a calculation process for channel changing, Formula 2 is used.

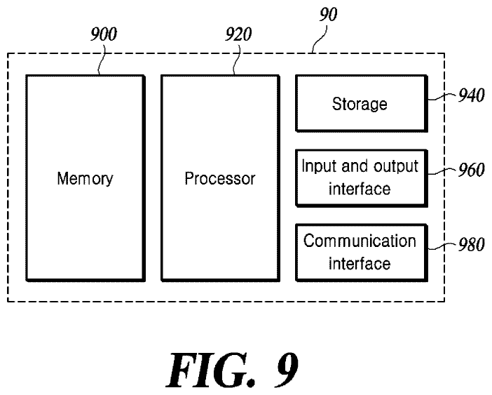

FIG. 9 is a diagram schematically illustrating a configuration of an exemplary computing device that can be used to implement the apparatuses and methods described in the present disclosure.

A computing device 90 may include some or all of a memory 900, a processor 920, a storage 940, an input and output interface 960, and a communication interface 980. The computing device 90 may be a stationary computing device such as a desktop computer or a server, as well as a mobile computing device such as a laptop computer or a smartphone. The computing device 90 may include any specialized hardware accelerator capable of efficiently processing operations for an artificial intelligence model. For example, the computing device 90 may include a graphic processing unit (GPU), a tensor processing unit (TPU), or a neural processing unit (NPU).

The memory 900 may store a program that causes the processor 920 to perform the methods or operations according to various embodiments of the present disclosure. For example, the program may include a plurality of instructions executable by the processor 920, and the above-described methods or operations may be performed by the plurality of instructions being executed by the processor 920. The memory 900 may be a single memory or a plurality of memories. In this case, information necessary to perform the methods or operations according to various embodiments of the present disclosure may be stored in the single memory or may be divided and stored in the plurality of memories. When the memory 900 includes the plurality of memories, the plurality of memories may be physically separated. The memory 900 may include at least one of a volatile memory and a nonvolatile memory. The volatile memory may include a static random access memory (SRAM), a dynamic random access memory (DRAM), or the like, and the nonvolatile memory may include a flash memory, or the like.

The processor 920 may include at least one core capable of executing at least one instruction. The processor 920 may execute instructions stored in the memory 900. The processor 920 may be a single processor or a plurality of processors.

The storage 940 maintains stored data even when power supplied to the computing device 90 is cut off. For example, the storage 940 may include a nonvolatile memory, and may include storage media such as a magnetic tape, an optical disc, or a magnetic disk. A program stored in the storage 940 may be loaded into the memory 900 before being executed by the processor 920. The storage 940 may store a file created in a program language, and a program generated from the file by a compiler or the like may be loaded into the memory 900. The storage 940 may store data to be processed by the processor 920 and/or data processed by the processor 920.

The input and output interface 960 can provide an interface with an input device such as a keyboard or a mouse and/or an output device such as a display device or a printer. A user can trigger the execution of the program in the processor 920 through the input device and/or confirm processing results of the processor 920 through the output device.

The communication interface 980 can provide access to an external network. The computing device 90 can communicate with another device through the communication interface 980.

A method for video restoration may comprise one or more operations described above. The method may be implemented in a non-transitory computer-readable medium storing instructions that, when executed, cause performance of one or more operations described herein.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A video restoration method, comprising:
receiving a target video to be restored and a source video to be used for restoration of the target video;
registering the source video with reference to the target video;
changing the target video and the registered source video from an RGB channel to a YUV channel;
designating and selecting an area with a larger difference in Y channel value between the target video and the registered source video as an area in which light reflection highlight occurs;
restoring the area in which the light reflection highlight occurs by replacing a Y channel value of the area in which the light reflection highlight occurs in the target video with a Y channel value of a corresponding area of the registered source video; and
changing the target video in which the area in which the light reflection highlight occurs has been restored, from a YUV channel to an RGB channel to generate a restored video.

2. The video restoration method of claim 1, wherein the target video and the source video are acquired using a multi-view video.

3. The video restoration method of claim 1, wherein the restoring of the area in which the light reflection highlight occurs in the target video includes adjusting the luminance of the Y channel value of the corresponding area in the registered source video using an interpolation scheme and replacing the Y channel value of the area in the target video with the adjusted luminance value.

4. The video restoration method of claim 3, wherein the interpolation scheme uses a formula:
$$Δ \tilde{p} ( i ) = \frac{1}{e - s} ( ( e - i ) Δ p ( s ) + ( i - s ) Δ p ( e ) )$$
(wherein, pixel domains p and q denote Y channel values of the source video and the target video, respectively, an i-th pixel value of the source video is p(i), an i-th estimated pixel value of the target video is \tilde{q}(i), \tilde{q}(i)=p(i)+Δ\tilde{p}(i) a start coordinate index of an area with a large difference in Y channel value is s, and an end coordinate index is e, Δp(s)=|q(s)−p(s)|, and Δp(e)=|q(e)−p(e)|).

5. The video restoration method of claim 4, wherein a formula
$$Δ \tilde{p} ( i ) = \frac{1}{2 {k}^{2}} {\sum }_{j} ( Δ ( j ) + Δ ( j ) )$$
(wherein, \tilde{q}(i) values of a row and a column are [symbol] (i)=pᵣ (i)+Δ [symbol] (i) and [symbol] (i)=p_{c} (i)+Δ [symbol] (i), respectively, and k indicates a window size including an area with a large difference in Y channel value) is used to apply the interpolation scheme to each of pixels of all rows and columns of the area in which the light reflection highlight occurs.

6. The video restoration method of claim 1, further comprising:
restoring the area in which the light reflection highlight occurs in the source video by using the target video as a source video for the source video when there is the area in which the light reflection highlight occurs in the source video.

7. A video restoration apparatus comprising at least one memory configured to store instructions, and at least one processor, the at least one processor executing the instructions to perform the processes of:
receiving a target video to be restored and a source video to be used for restoration of the target video;
registering the source video with reference to the target video;
changing the target video and the registered source video from an RGB channel to a YUV channel;
designating and selecting an area with a larger difference in Y channel value between the target video and the registered source video as an area in which light reflection highlight occurs;
restoring the area in which the light reflection highlight occurs by replacing a Y channel value of the area in which the light reflection highlight occurs in the target video with a Y channel value of a corresponding area of the registered source video; and
changing the target video in which the area in which the light reflection highlight occurs has been restored, from a YUV channel to an RGB channel to generate a restored video.

8. The video restoration apparatus of claim 7, wherein the target video and the source video are acquired using a multi-view video.

9. The video restoration apparatus of claim 7, wherein the process of restoring the area in which the light reflection highlight occurs in the target video includes adjusting the luminance of the Y channel value of the corresponding area in the registered source video using an interpolation scheme and replacing the Y channel value of the area in the target video with the adjusted luminance value.

10. The video restoration apparatus of claim 9, wherein the interpolation scheme uses a formula:
$$Δ \tilde{p} ( i ) = \frac{1}{e - s} ( ( e - i ) Δ p ( s ) + ( i - s ) Δ p ( e ) )$$
(wherein, pixel domains p and q denote Y channel values of the source video and the target video, respectively, an i-th pixel value of the source video is p(i), an i-th estimated pixel value of the target video is \tilde{q}(i), \tilde{q}(i)=p(i)+Δ\tilde{p}(i) a start coordinate index of an area with a large difference in Y channel value is s, and an end coordinate index is e, Δp(s)=|q(s)−p(s)|, and Δp(e)=|q(e)−p(e)|).

11. The video restoration apparatus of claim 10, wherein a formula
$$Δ \tilde{p} ( i ) = \frac{1}{2 {k}^{2}} {\sum }_{j} ( Δ ( j ) + Δ ( j ) )$$
(wherein, \tilde{q}(i) values of a row and a column are [symbol] (i)=pᵣ (i)+Δ [symbol] (i) and [symbol] (i)=p_{c} (i)+Δ [symbol] (i), respectively, and k indicates a window size including an area with a large difference in Y channel value) is used to apply the interpolation scheme to each of pixels of all rows and columns of the area in which the light reflection highlight occurs.

12. The video restoration apparatus of claim 7, further performing:
a process of restoring the area in which the light reflection highlight occurs in the source video by using the target video as a source video for the source video when there is the area in which the light reflection highlight occurs in the source video.
